(19) United States
(12) Patent Application Publication
(10) Pub. No.: US 2024/0401992 A1
(43) Pub. Date: Dec. 5, 2024

(54) CORRECTION OF GAS FLOW IN THE PRESENCE OF LIQUID IN A GAS PIPELINE

(71) Applicants: Chevron U.S.A. Inc., San Ramon, CA (US); The University of Tulsa, Tulsa, OK (US)

(72) Inventors: Pamela I. Chacon, Magnolia, TX (US); Lisa A. Brenskelle, Houston, TX (US); Eduardo Pereyra, Tulsa, OK (US); Mike Nasr, Tulsa, OK (US)

(21) Appl. No.: 18/807,633

(22) Filed: Aug. 16, 2024

Related U.S. Application Data
(63) Continuation-in-part of application No. PCT/US2023/015928, filed on Mar. 22, 2023.
(60) Provisional application No. 63/322,331, filed on Mar. 22, 2022.

(51) Int. Cl. G01F 1/36; F17D 1/04

(52) U.S. Cl. CPC G01F 1/36; F17D 1/04

(57) ABSTRACT

Flow restriction differential pressure and a third tap differential pressure for a pipe are used to determine a pressure loss ratio for the pipe/system that includes a flow restriction. The pressure loss ratio is used to determine whether liquid is present in the pipe. If liquid is present in the pipe, a value of the Lockhart-Martinelli parameter is determined and used to (1) correct gas flow measurement for the pipe and (2) determine a liquid flow rate in the pipe.

### CROSS-REFERENCE TO RELATED APPLICATIONS

The present application is a bypass continuation-in-part of International Application No. PCT/US2023/015928, filed Mar. 22, 2023, entitled “CORRECTION OF GAS FLOW IN THE PRESENCE OF LIQUID IN A GAS PIPELINE,” which claims the benefit of U.S. Provisional Application No. 63/322,331, entitled “CORRECTION OF GAS FLOW IN THE PRESENCE OF LIQUID IN A GAS PIPELINE,” which was filed on Mar. 22, 2022, the entirety of each of which is hereby incorporated herein by reference.

### FIELD

The present disclosure relates generally to the field of correcting gas flow in a gas pipeline based on the presence of liquid in the gas pipeline.

### BACKGROUND

Liquid in a gas pipeline may impact the accuracy of gas flow measurement. Presence of liquid in the gas pipeline may cause over/under reading of gas flow in the gas pipeline. Determination of liquid quantity in the pipe may have significant impact on revenue.

### SUMMARY

This disclosure relates to correcting gas flow in the presence of liquid in a gas pipeline. Flow restriction differential pressure information, third tap differential pressure information, and/or other information may be obtained. The flow restriction differential pressure information may define a flow restriction differential pressure between a first point along a pipe and a second point along the pipe. A flow restriction may be located along the pipe. The first point may be on a first side of the flow restriction and the second point may be on a second side of the flow restriction. The third tap differential pressure information may define a third tap differential pressure between the first point along the pipe and a third point along the pipe. The third point may be on the second side of the flow restriction and may be downstream of the second point. A pressure loss ratio may be determined based on the flow restriction differential pressure, the third tap differential pressure, and/or other information. Whether liquid is present in the pipe may be determined based on the pressure loss ratio and/or other information. Responsive to the determination that liquid is present in the pipe, a value of the Lockhart-Martinelli parameter for the pipe may be determined. A liquid-corrected gas flow rate in the pipe may be determined based on the value of the Lockhart-Martinelli parameter and/or other information.

A system for correcting gas flow rate in the presence of liquid in a gas pipeline may include one or more electronic storage, one or more processors and/or other components. The electronic storage may store flow restriction differential pressure information, information relating to a flow restriction differential pressure, third tap differential pressure information, information relating to a third tap differential pressure, information relating to a pressure loss ratio, information relating to liquid presence in the pipe, information relating to Lockhart-Martinelli parameter, measured gas flow rate in the pipe, information relating to a measured gas flow rate in the pipe, information relating to a liquid-corrected gas flow rate in the pipe, and/or other information.

The processor(s) may be configured by machine-readable instructions. Executing the machine-readable instructions may cause the processor(s) to facilitate correcting gas flow in the presence of liquid in a gas pipeline. The machine-readable instructions may include one or more computer program components. The computer program components may include one or more of a differential pressure component, a pressure loss ratio component, a liquid presence component, a Lockhart-Martinelli component, a correction component, and/or other computer program components.

The differential pressure component may be configured to obtain flow restriction differential pressure information and/or other information. The flow restriction differential pressure information may define a flow restriction differential pressure between a first point along a pipe and a second point along the pipe. A flow restriction may be located along the pipe. The first point may be on a first side of the flow restriction and the second point may be on a second side of the flow restriction.

In some implementations, the flow restriction differential pressure may be measured using a fast response differential pressure sensor. Overread or underread of a gas flow rate in the pipe may be determined based on frequency of the flow restriction differential pressure measured using the fast response differential pressure sensor and/or other information. The overread or the underread of the gas flow rate in the pipe may be determined further based on amplitude of the flow restriction differential pressure measured using the fast response differential pressure sensor and/or other information.

The differential pressure component may be configured to obtain third tap differential pressure information and/or other information. The third tap differential pressure information may define a third tap differential pressure between the first point along the pipe and a third point along the pipe. The third point may be on the second side of the flow restriction and may be downstream of the second point.

The pressure loss ratio component may be configured to determine a pressure loss ratio. The pressure loss ratio may be determined based on the flow restriction differential pressure, the third tap differential pressure, and/or other information. In some implementations, the pressure loss ratio may be determined as a ratio of the third tap differential pressure and the flow restriction differential pressure.

The liquid presence component may be configured to determine whether liquid is present in the pipe. Whether liquid is present in the pipe may be determined based on the pressure loss ratio and/or other information. In some implementations, the determination of whether liquid is present in the pipe based on the pressure loss ratio may include comparison of a difference between the pressure loss ratio and an ideal pressure loss ratio to a threshold to determine whether liquid is present in the pipe.

The Lockhart-Martinelli component may be configured to, responsive to the determination that liquid is present in the pipe, determine a value of Lockhart-Martinelli parameter for the pipe. In some implementations, the value of the Lockhart-Martinelli parameter for the pipe may be determined based on a difference between the pressure loss ratio and an ideal pressure loss ratio, density ratio of gas to liquid, geometry of the pipe, and/or other information. In some implementations, the value of the Lockhart-Martinelli parameter for the pipe may be determined based on the dominant frequency of fast response pressure measurements from the pipe and/or other information. The fast response pressure measurements from the pipe may include fast response absolute pressure measurements and/or fast response differential pressure measurements. The fast response pressure measurements may be obtained upstream from the flow restriction, downstream from the flow restriction, at the flow restriction, and/or across the flow restriction.

The correction component may be configured to determine a liquid-corrected gas flow rate in the pipe. The liquid-corrected gas flow rate in the pipe may be determined based on the value of the Lockhart-Martinelli parameter, a measured gas flow rate in the pipe, and/or other information.

In some implementations, a liquid flow rate in the pipe may be determined based on the liquid-corrected gas flow rate, the value of the Lockhart-Martinelli parameter, and/or other information. Total transferred liquid over a time period may be determined based on the liquid flow rate.

In some implementations, total transferred gas over a time period may be determined based on the liquid-corrected gas flow rate and/or other information.

In some implementations, determination of the liquid-corrected gas flow rate in the pipe based on the value of the Lockhart-Martinelli parameter and the measured gas flow rate in the pipe may include: (1) determination of overread or underread of the gas flow rate in the pipe based on the value of the Lockhart-Martinelli parameter and/or other information; and (2) correction of the measured gas flow rate in the pipe based on the overread or the underread of the gas flow rate and/or other information.

In some implementations, the determination of the liquid-corrected gas flow rate in the pipe may be iterated based on a comparison of the latest calculated value of the liquid-corrected gas flow rate in the pipe and the previously calculated value of the liquid-corrected gas flow rate in the pipe, and/or other information. In some implementations, the iterative determination of the liquid-corrected gas flow rate in the pipe may include determination of a value of a gas Froude number. In some implementations, the iterative determination of the liquid-corrected gas flow rate in the pipe may further include determination of a value of a superficial liquid velocity based on the value of the gas Froude number and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for correcting gas flow in the presence of liquid in a gas pipeline.

FIG. 2 illustrates an example method for correcting gas flow in the presence of liquid in a gas pipeline.

FIG. 3 illustrates an example pipe.

FIG. 4A illustrates an example flow diagram for correcting gas flow in the presence of liquid in a gas pipeline.

FIG. 4B illustrates an example flow diagram for iteratively correcting gas flow in the presence of liquid in a gas pipeline.

FIG. 4C illustrates an example flow diagram for iteratively correcting gas flow in the presence of liquid in a gas pipeline.

FIG. 5 illustrates an example correction of gas flow rate.

FIG. 6 illustrates example correlations between Strouhal number and Lockhart-Martinelli number.

FIG. 7 illustrates an example correction of gas flow rate.

### DETAILED DESCRIPTION

The present disclosure relates to correcting gas flow in the presence of liquid in a gas pipeline. Flow restriction differential pressure and a third tap differential pressure for a pipe are used to determine a pressure loss ratio for the pipe/system that includes a flow restriction. The pressure loss ratio is used to determine whether liquid is present in the pipe. If liquid is present in the pipe, a value of the Lockhart-Martinelli parameter is determined and used to (1) correct gas flow measurement for the pipe and (2) determine a liquid flow rate in the pipe.

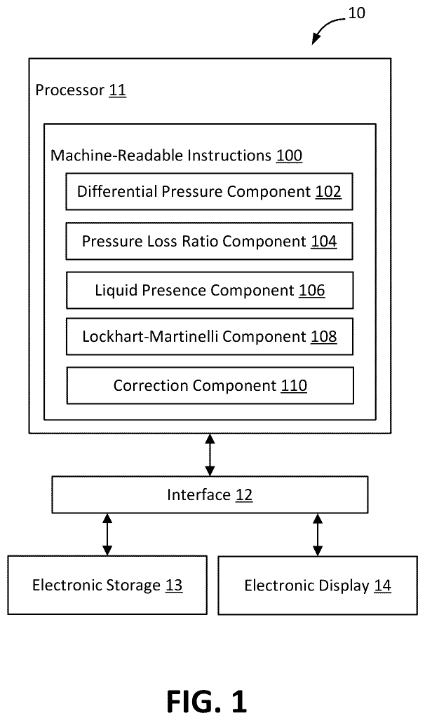

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Flow restriction differential pressure information, third tap differential pressure information, and/or other information may be obtained by the processor 11. The flow restriction differential pressure information may define a flow restriction differential pressure between a first point along a pipe and a second point along the pipe. A flow restriction may be located along the pipe. The first point may be on a first side of the flow restriction and the second point may be on a second side of the flow restriction. The third tap differential pressure information may define a third tap differential pressure between the first point along the pipe and a third point along the pipe. The third point may be on the second side of the flow restriction and may be downstream of the second point. A pressure loss ratio may be determined by the processor 11 based on the flow restriction differential pressure, the third tap differential pressure, and/or other information. Whether liquid is present in the pipe may be determined by the processor 11 based on the pressure loss ratio and/or other information. Responsive to the determination that liquid is present in the pipe, a value of the Lockhart-Martinelli parameter for the pipe may be determined by the processor 11. A liquid-corrected gas flow rate in the pipe may be determined by the processor 11 based on the value of the Lockhart-Martinelli parameter and/or other information.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store flow restriction differential pressure information, information relating to a flow restriction differential pressure, third tap differential pressure information, information relating to a third tap differential pressure, information relating to a pressure loss ratio, information relating to liquid presence in the pipe, information relating to Lockhart-Martinelli parameter, measured gas flow rate in the pipe, information relating to a measured gas flow rate in the pipe, information relating to a liquid-corrected gas flow rate in the pipe, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present information relating to a pipe, information relating to a flow restriction differential pressure, information relating to a third tap differential pressure, information relating to a measured gas flow rate in the pipe, information relating to presence of liquid in the pipe, information relating to Lockhart-Martinelli parameter, information relating to a liquid-corrected gas flow rate, information relating to a liquid flow rate, and/or other information.

Accurately measuring flow of gas and liquid in a gas pipeline may be critical for many applications, such as reservoir and well management, production optimization, flow assurance issues, production allocation, and custody transfer. The presence of liquid in a pipe may reduce the accuracy of gas flow measurement in the pipe. For example, liquid flowing in a pipe may result in overread/underread of gas flow measurement in the pipe. Liquid flowing in a pipe may result in the measured gas flow rate being higher than the actual gas flow rate in the pipe. Quantifying the liquid in the pipe may enable more accurate measurement of gas flow in the pipe and allow for liquid transfer through the pipe to be measured. However, existing wet gas (gas that includes/carries liquid) meters leverage multiple measurement components and are costly to install and maintain.

The current disclosure provides a simple and low-cost supplemental add-on to a flow restriction (e.g., an orifice plate, a Venturi, a cone, or a wedge meter) in a pipe to accurately quantify liquid in the pipe (e.g., liquid fraction in the pipe) and enable accurate measurement of gas flow in the pipe. The current disclosure also enables liquid transfer through the pipe to be accurately measured (estimated, calculated). The current disclosure utilizes a third tap for the flow restriction to quantify liquid in the pipe (quantify liquid in wet gas flowing through the pipe). The current disclosure utilizes one or more fast response differential pressure sensors and frequency analysis to quantify liquid in the pipe. The third tap and the fast response differential pressure sensor(s) may be used in conjunction or separately to quantify liquid in the pipe. The current disclosure provides a simple and low-cost technique to detect the presence of liquid in a pipe and quantify the effect of the liquid in the pipe on gas flow measurement, as well as quantify the liquid flowing in the pipe.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate correcting gas flow in the presence of liquid in a gas pipeline. The machine-readable instructions 100 may include one or more computer program components. The machine-readable instructions 100 may include a differential pressure component 102, a pressure loss ratio component 104, a liquid presence component 106, a Lockhart-Martinelli component 108, a correction component 110, and/or other computer program components.

The differential pressure component 102 may be configured to obtain differential pressure information and/or other information. Obtaining differential pressure information may include one or more of accessing, acquiring, analyzing, determining, examining, generating, identifying, loading, locating, measuring, opening, receiving, retrieving, reviewing, selecting, storing, and/or otherwise obtaining the differential pressure information. The differential pressure component 102 may obtain differential pressure information from one or more locations. For example, the differential pressure component 102 may obtain differential pressure information from a storage location, such as the electronic storage 13, electronic storage of a device accessible via a network, and/or other locations. The differential pressure component 102 may obtain differential pressure information from one or more hardware components (e.g., a computing device, a pressure sensor, a differential pressure sensor) and/or one or more software components (e.g., software running on a computing device). For example, the differential pressure component 102 may obtain differential pressure information by using one or more pressure sensors and/or one or more differential pressure sensors to measure the differential pressure between two different points (locations) along a pipe. In some implementations, a pressure sensor may include a fast response pressure sensor (dynamic pressure sensor). In some implementations, a differential pressure sensor may include a fast response differential pressure sensor.

The differential pressure information may define a differential pressure between two points along a pipe. The differential pressure between two points along a pipe may refer to the difference in pressure between the two points along the pipe. The differential pressure information may define a differential pressure between two points along a pipe by including information that characterizes, describes, delineates, identifies, is associated with, quantifies, reflects, sets forth, and/or otherwise defines one or more of value, property, quality, quantity, attribute, feature, and/or other aspects of the differential pressure between the two points along the pipe. The differential pressure information may directly and/or indirectly define a differential pressure between two points along a pipe. For example, the differential pressure information may define a differential pressure between two points along a pipe by including information that specifies the value of the differential pressure between the two points along the pipe and/or information that may be used to determine the value of the differential pressure between the two points along the pipe (e.g., the values of two pressure measurements at the two points along the pipe from which the differential pressure between the two points may be calculated). Other types of differential pressure information are contemplated.

Differential pressure information obtained by the differential pressure component 102 may include flow restriction differential pressure information, third tap differential pressure information, and/or other differential pressure information. The flow restriction differential pressure information may define a flow restriction differential pressure between two points along a pipe. A flow restriction differential pressure may refer to a differential pressure measured using a flow restriction. A flow restriction differential pressure may refer to a difference in pressure between two different sides of a flow restriction. A flow restriction may refer to one or more devices and/or one or more configurations of a pipe that restricts the flow of fluid through the pipe. A flow restriction may change the cross-sectional area of the pipe through which fluid flows. A flow restriction may be part of the pipe. A flow restriction may be installed in the pipe. A flow restriction may be a single phase differential pressure-based flow measurement device. For example, a flow restriction on a pipe may include an orifice plate, a Venturi, a cone, or a wedge meter. Other types of flow restriction are contemplated.

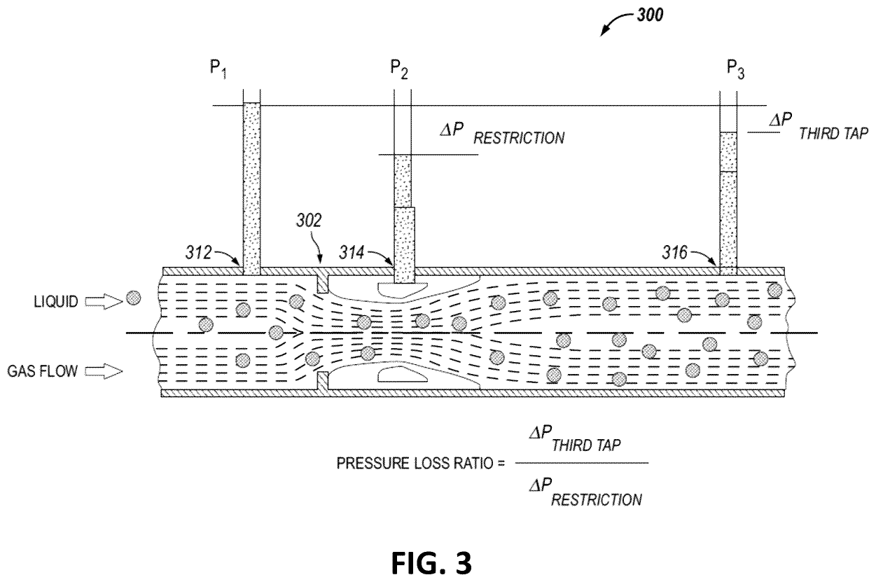

For example, FIG. 3 illustrates an example pipe 300. The flow restriction on the pipe 300 may include an orifice plate 302. The orifice plate 302 may be located along the pipe 300. The orifice plate 302 may include a thin plate with a hole. The pipe 300 may include holes (taps) to measure pressure at different points 312, 314, 316 along the pipe. The flow restriction differential pressure (ΔP_{restriction}) may refer to the difference in pressure between the point 312 and the point 314 along the pipe 300. The points 312, 314 may be on different sides of the orifice plate 302. While the pipe 300 in FIG. 3 is shown with an orifice plate, the pipe 300 is merely provided as an example and is not meant to be limiting. Use of other flow restriction is contemplated.

Differential pressure information between other locations of the pipe may be obtained. For example, differential pressure may be measured upstream and/or downstream from a flow restriction. The taps to measure pressure at different points along the pipe may be located before the flow restriction to obtain upstream differential pressure. The taps to measure pressure at different points along the pipe may be located after the flow restriction to obtain downstream differential pressure. As another example, differential pressure may be measured from different locations on the circumference of the pipe. For example, rather than having the taps aligned along the pipe (e.g., the tap 312 and the tap 314 located at the top of the pipe 300 as shown in FIG. 3), the taps may not be aligned along the pipe (e.g., taps located at the top and the sides/bottom of the pipe). The taps may also be aligned but located at other points along the pipe circumference (i.e., not the top). Gas flow rate error correction may be performed using the differential pressure measured at other locations.

The third tap differential pressure information may define a third tap differential pressure between two points along the pipe. One of the two points for the measurement of the third tap differential pressure may be the same as one of the two points for the measurement of the flow restriction differential pressure. The other one of the two points for the measurement of the third tap differential pressure may be at a third tap for the pipe and may be different from the two points for the measurement of the flow restriction differential pressure. The third tap may be located downstream from the holes for the flow restriction differential pressure measurement.

For example, referring to FIG. 3, the third tap may be located at the point 316. The third tap differential pressure (ΔP_{third tap}) may refer to the difference in pressure between the point 312 and the point 316 along the pipe 300. The points 314, 316 may be on the same side of the orifice plate 302. The point 316 may be downstream of the point 314. Placement of taps/holes at other points along the pipe 300 are contemplated.

The pressure loss ratio component 104 may be configured to determine a pressure loss ratio. Determining the pressure loss ratio may include ascertaining, approximating, calculating, establishing, estimating, finding, identifying, obtaining, quantifying, selecting, setting, and/or otherwise determining the pressure loss ratio. The pressure loss ratio may be determined based on the flow restriction differential pressure, the third tap differential pressure, and/or other information. Pressure loss ratio determined based on the flow restriction differential pressure and the third tap differential pressure may be referred to as measured pressure loss ratio (PLR_{measured}). The pressure loss ratio may be determined as a ratio of the third tap differential pressure and the flow restriction differential pressure:

$$P L {R}_{m e a s u r e d} = \frac{Δ {P}_{third tap}}{Δ {P}_{restriction}}$$

The liquid presence component 106 may be configured to determine whether liquid is present in the pipe. Determining whether liquid is present in the pipe may include determining whether wet gas or dry gas is flowing through the pipe. Determining whether liquid is present in the pipe may include determining whether liquid is flowing in the pipe. Whether liquid is present in the pipe may be determined based on the pressure loss ratio and/or other information. The value of the pressure loss ratio may be used to determine whether the gas that is flowing through the pipe includes/is carrying liquid.

In some implementations, the determination of whether liquid is present in the pipe based on the pressure loss ratio may include comparison of a difference between the pressure loss ratio and an ideal pressure loss ratio to a threshold to determine whether liquid is present in the pipe. The ideal pressure loss ratio may refer to the value of pressure loss ratio that would be present for transport of a single phase gas through the pipe. The ideal pressure loss ratio may refer to the value of pressure loss ratio when liquid is not present in gas flowing through the pipe. The difference between the pressure loss ratio in the pipe (PLR_{measured}) and the ideal pressure loss ratio may indicate how far the condition in the pipe is from a single phase condition (gas only condition). When liquid is present in the pipe, the pressure loss ratio in the pipe may deviate from the ideal pressure loss ratio.

Comparison of the difference between the pressure loss ratio and the ideal pressure loss ratio to a threshold may enable control of how far the pressure loss ratio can deviate from the ideal pressure loss ratio before liquid is determined to be present in the pipe. The value of the threshold may control how far the pressure loss ratio can deviate from the ideal pressure loss ratio before liquid is determined to be present in the pipe. For example, small deviation of the pressure loss ratio from the ideal pressure loss ratio (deviation less than the threshold) may be ignored while large deviation of the pressure loss ratio from the ideal pressure loss ratio (deviation greater than the threshold) may indicate that liquid is present in the pipe.

Example comparison of the difference between the pressure loss ratio (PLR_{measured}) and the ideal pressure loss ratio (PLR_{ISO}) to a threshold is provided below:

$$\begin{matrix}\frac{P L {R}_{m e a s u r e d} - P L {R}_{ISO}}{P L {R}_{1 S O}} * 100 \% > Threshold \% \\ {PLR}_{ISO} = \frac{\sqrt{1 - {β}^{4} ( 1 - {{C}_{d}}^{2} )} - {C}_{d} {β}^{2}}{\sqrt{1 - {β}^{4} ( 1 - {{C}_{d}}^{2} )} + {C}_{d} {β}^{2}}\end{matrix}$$

where

$$β = \frac{d}{D} ,$$

d=orifice diameter, D=pipe diameter, C_{d}=coefficient of discharge

In the above, the ideal pressure loss ratio may be calculated using an ISO correlation. Other calculation of the ideal pressure loss ratio is contemplated.

In some implementations, the determination of whether liquid is present in the pipe based on the pressure loss ratio may include comparison of the value of the pressure loss ratio to a dry value of the pressure loss ratio and/or a liquid value of the pressure loss ratio. A dry value of the pressure loss ratio may refer to a value of the pressure loss ratio when the pipe is known to not include any liquid. For example, the pressure loss ratio may be computed when the pipe is known to not include any liquid, and this value of the pressure loss ratio (dry gas baseline value) may be compared with the current pressure loss ratio to determine whether the pipe is currently dry (not including liquid) or wet (including liquid). A liquid value of the pressure loss ratio may refer to a value of the pressure loss ratio when the pipe is known to include liquid. For example, the pressure loss ratio may be computed when the pipe is known to include a certain amount of liquid (e.g., the smallest amount of liquid for which liquid presence is desired to be detected), and this value of the pressure loss ratio (wet gas baseline value) may be compared with the current pressure loss ratio to determine whether the pipe is currently dry or wet.

The Lockhart-Martinelli component 108 may be configured to, responsive to the determination that liquid is present in the pipe, determine a value of Lockhart-Martinelli parameter for the pipe. Determining the value of Lockhart-Martinelli parameter for the pipe may include ascertaining, approximating, calculating, establishing, estimating, finding, identifying, obtaining, quantifying, selecting, setting, and/or otherwise determining the value of Lockhart-Martinelli parameter for the pipe. The Lockhart-Martinelli parameter may refer to a dimensionless number used in two-phase flow calculations. The Lockhart-Martinelli parameter may be used to indicate the degree of “wetness” of a wet gas at actual conditions. The value of the Lockhart-Martinelli parameter may express the liquid fraction of a flowing fluid. The value of the Lockhart-Martinelli parameter may indicate how much liquid is present in the gas. The Lockhart-Martinelli parameter (XLM) may be defined as set below, where Q is volume flow rate of liquid, Q_{g} is volume flow rate of gas, mₗ is mass flow rate of liquid, m_{g} is mass flow rate of gas, ρₗ is density of liquid, and ρ_{g} is density of gas:

$${X}_{L M} = \frac{{Q}_{l}}{{Q}_{g}} \sqrt{\frac{{ρ}_{l}}{{ρ}_{g}}} = \frac{{m}_{l}}{{m}_{g}} \sqrt{\frac{{ρ}_{g}}{{ρ}_{l}}}$$

In some implementations, the value of the Lockhart-Martinelli parameter for the pipe may be determined based on a difference between the pressure loss ratio and an ideal pressure loss ratio, density ratio of gas to liquid, geometry of the pipe, and/or other information. The value of the Lockhart-Martinelli parameter may be a function of (1) the difference between the pressure loss ratio and the ideal pressure loss ratio (e.g., PLR_{ISO}), (2) density ratio of gas to liquid, and (3) the geometry of the pipe (orifice to pipe diameter ratio). For example, the value of the Lockhart-Martinelli parameter (X_{LM}) may be expressed as:

$${X}_{L M} = f ( Y , DR , β )$$

where Y=PLR_{measured}−PLR_{ISO},

$$DR = \frac{{ρ}_{g}}{{ρ}_{l}} ,$$

ρ_{g}=gas density, ρₗ=liquid density, and

$$β = \frac{d}{D}$$

For example, the value of the Lockhart-Martinelli parameter may be calculated using one or more of the relationships/correlations set forth below. Use of other relationships/correlations to calculate the value of the Lockhart-Martinelli parameter is contemplated.

$${X}_{LM} = \frac{6.41 \cdot Y}{{β}^{4.9}} {DR}^{0.92}$$

$${X}_{LM} = \frac{0.0 \; 006925 \cdot {Y}^{2}}{{β}^{13.2434}} + 365 DR \cdot Y$$

$${X}_{LM} = \frac{exp ( - 9.0 \; 742 \cdot β + 621.7 \; 28 \cdot DR + 24.3 \; 882 \cdot Y - 1.2095 )}{2} + \frac{\frac{0.001846 \cdot {Y}^{2}}{{β}^{11.9647}} + 358.19 \cdot DR \cdot Y}{2}$$

The correction component 110 may be configured to determine a liquid-corrected gas flow rate in the pipe. Determining the liquid-corrected gas flow rate in the pipe may include ascertaining, approximating, calculating, establishing, estimating, finding, identifying, obtaining, quantifying, selecting, setting, and/or otherwise determining the value of the liquid-corrected gas flow rate in the pipe. A liquid-corrected gas flow rate in the pipe may refer to a gas flow rate that has been corrected to account for the presence of liquid in the pipe. A liquid-corrected gas flow rate in the pipe may refer to a gas flow rate that has been adjusted from the measured gas flow rate to account for the error in gas flow rate measurement due to the presence of liquid in the pipe. A gas flow rate in the pipe may refer to a rate at which gas is flowing through the pipe (e.g., by mass, by volume).

In some implementations, the liquid-corrected gas flow rate in the pipe may be determined based on comparison of the value of the Lockhart-Martinelli parameter to a threshold. Comparison of the value of the Lockhart-Martinelli parameter to a threshold may enable control of how high the value of the Lockhart-Martinelli parameter can rise before the gas flow rate in the pipe is corrected for the presence of liquid in the pipe. The value of the threshold may control how high the value of the Lockhart-Martinelli parameter can rise before liquid is determined to have sufficient impact on the accuracy of gas flow rate measurement to correct the gas flow rate measurement. For example, small values of the Lockhart-Martinelli parameter (e.g., less than 0.02) may be ignored as having little/no impact on the accuracy of the gas flow rate measurement while higher values of the Lockhart-Martinelli parameter (e.g., greater than 0.02) may indicate that the accuracy of the gas flow rate measurement is being sufficiently impacted such that the measured gas flow rate should be corrected.

The liquid-corrected gas flow rate in the pipe may be determined based on the value of the Lockhart-Martinelli parameter, a measured gas flow rate in the pipe, and/or other information. Determination of the liquid-corrected gas flow rate in the pipe may include (1) determination of overread/underread of the gas flow rate in the pipe based on the value of the Lockhart-Martinelli parameter and other information, and (2) correction of the measured gas flow rate in the pipe using the overread/underread of the gas flow rate. Use of the value of the Lockhart-Martinelli parameter allows the liquid-corrected gas flow rate to be determined without a priori knowledge of the liquid flow rate in the pipe. That is, the value of the Lockhart-Martinelli parameter, rather than the liquid flow rate in the pipe, may be used to correct the gas flow rate in the pipe.

The overread/underread of the gas flow rate in the pipe may be determined via one or more methods that utilizes the value of the Lockhart-Martinelli parameter. For example, ISO TR 12748 provides the following method to calculate the overread (OR) of the gas flow rate in the pipe using the value of the Lockhart-Martinelli parameter.

$$OR = \sqrt{1 + C \cdot {X}_{LM} + {X}_{LM}^{2}} , where C = {( \frac{{ρ}_{g}}{{ρ}_{l}} )}^{n} + {( \frac{{ρ}_{l}}{{ρ}_{g}} )}^{n}$$

gas Froude number,

$${Fr}_{g} = \sqrt{\frac{Superficial Gas Inertia Force}{Liquid Gravity Force}} = \frac{{Vs}_{g}}{\sqrt{g \cdot D}} \cdot \sqrt{\frac{{ρ}_{g}}{{ρ}_{l} - {ρ}_{g}}} ,$$

where Vs_{g} is superficial gas velocity, g is the gravitational acceleration, and
D is the inlet pipe diameter
water to liquid mass ratio,

$$WLMR = \frac{{\dot{m}}_{w}}{{\dot{m}}_{l}} ,$$

where m_{w} is mass of water and m is mass of liquid

$$A = 0.4 - 0.1 * exp ( - WLMR )$$

$${Fr}_{g , transition} = 1.5 + 0.2 * W L M R$$

$$if {Fr}_{g} < {Fr}_{g , transition} \to n = {( \frac{1}{\sqrt{2}} - \frac{A}{\sqrt{{Fr}_{g , transition}}} )}^{2}$$

$$if {Fr}_{g} > {Fr}_{g , transition} \to n = {( \frac{1}{\sqrt{2}} - \frac{A}{\sqrt{{Fr}_{g}}} )}^{2}$$

Using the approach of the current disclosure, the overread of the gas flow rate may be determined within +3% of the actual value at 95% confidence interval. With the exact (rather than estimated) value of the Lockhart-Martinelli parameter, the overread of the gas flow rate may be determined within ±2% of the actual value at 95% confidence interval. Thus, the current disclosure enables highly accurate calculation of the overread of the gas flow rate. Other calculation of the overread of the gas flow rate in the pipe is contemplated.

The gas flow rate in the pipe may be measured using the flow restriction and/or other devices. For example, the gas flow rate in the pipe may be measured using static pressure reading, differential pressure reading, gas composition in the pipe, the temperature in the pipe, and/or other information. Such measurement of the gas flow rate may provide uncorrected gas flow rate. The measured gas flow rate may include error (overread/underread) caused by the presence of liquid in the pipe. The measured gas flow rate may be corrected for the overread/underread to calculate the liquid-corrected gas flow rate in the pipe. For example, the mass flow rate of gas (m_{g uncorrected}) measured in the pipe may be corrected for the overread to calculate the liquid-corrected mass flow rate of gas (m_{g}) as set forth below. Volume flow rate of gas may be measured and corrected using the overread. The underread may be used to correct the mass flow rate and/or volume flow rate of gas in the pipe in the same/similar way. Other correction of the gas flow rate in the pipe is contemplated.

$${m}_{g} = \frac{{m}_{g uncorrected}}{OR}$$

In some implementations, total transferred gas over a time period may be determined based on the liquid-corrected gas flow rate and/or other information. Total transferred gas over a time period may refer to the total amount of gas that is transferred over the time period using the pipe. The liquid-corrected gas flow rate may be multiplied by the time period to accurately determine how much gas has been transferred over the time period using the pipe. Such determination of the total transferred gas over the time period may enable more accurate tracking of gas transfer (e.g., for billing purposes) and/or more accurate control/allocation of gas transfer.

In some implementations, the correction component 110 may be configured to determine a liquid flow rate in the pipe. Determining a liquid flow rate in the pipe may include ascertaining, approximating, calculating, establishing, estimating, finding, identifying, obtaining, quantifying, selecting, setting, and/or otherwise determining the liquid flow rate in the pipe. A liquid flow rate in the pipe may refer to a rate at which liquid is flowing through the pipe (e.g., by mass, by volume).

The liquid flow rate in the pipe may be determined based on the liquid-corrected gas flow rate, the value of the Lockhart-Martinelli parameter, and/or other information. The mass flow rate of liquid (mₗ) in the pipe may be calculated using the liquid-corrected gas flow rate (m_{g}), the value of the Lockhart-Martinelli parameter, and the density ratio of liquid and gas (ρₗ/ρ_{g}) as set forth below. Other calculation of the liquid flow rate in the pipe is contemplated.

$${m}_{l} = {X}_{LM} \cdot {m}_{g} \sqrt{\frac{{ρ}_{l}}{{ρ}_{g}}}$$

In some implementations, total transferred liquid over a time period may be determined based on the liquid flow rate and/or other information. Total transferred liquid over a time period may refer to the total amount of liquid that is transferred over the time period using the pipe. The liquid flow rate may be multiplied by the time period to accurately determine how much liquid has been transferred over the time period using the pipe. Such determination of the total transferred liquid over the time period may enable more accurate tracking of liquid transfer (e.g., for billing purposes) and/or more accurate control/allocation of liquid transfer.

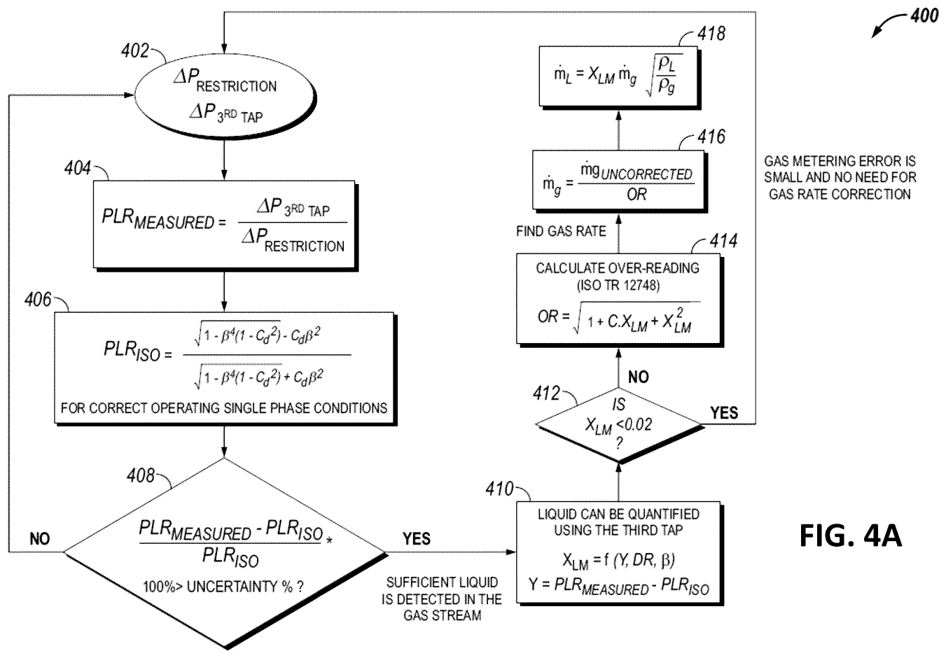

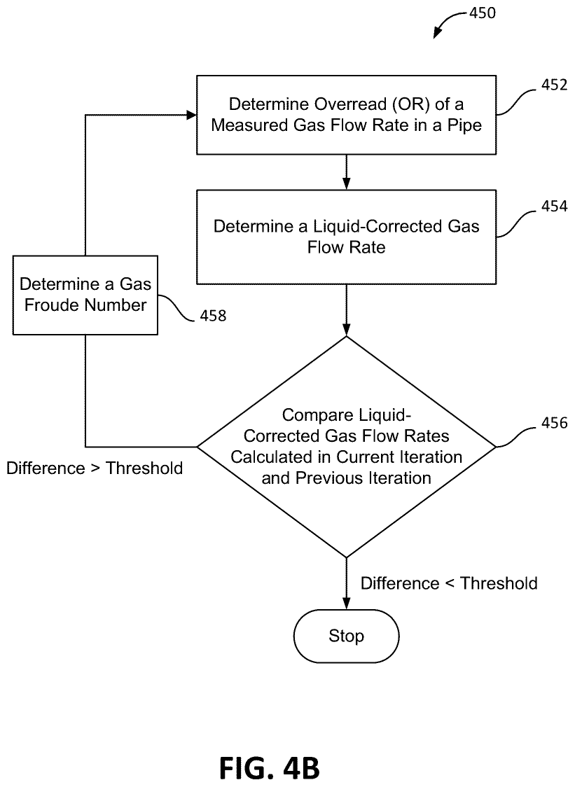

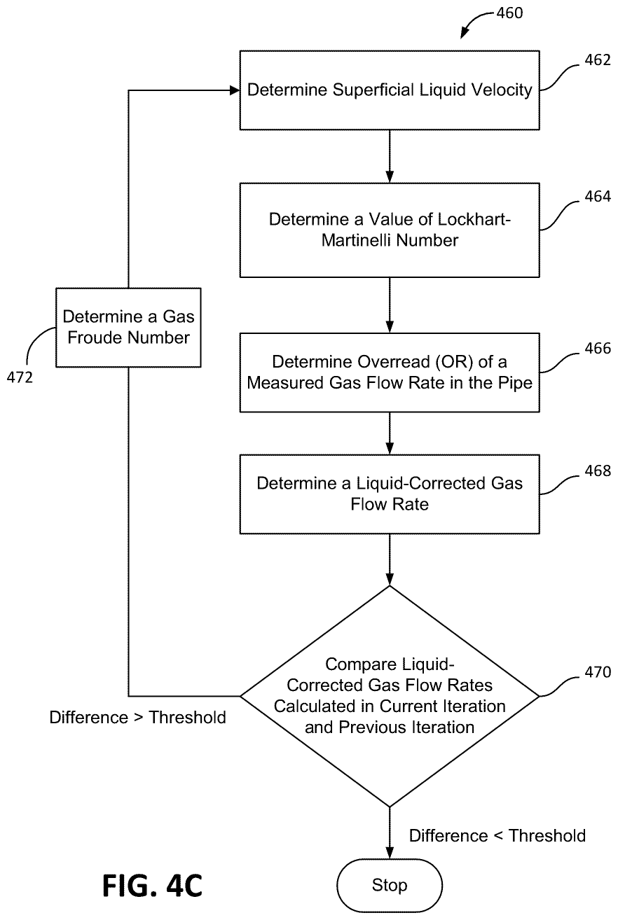

FIG. 4A illustrates an example flow diagram 400 for correcting gas flow in the presence of liquid in a gas pipeline. At step 402, a flow restriction differential pressure and a third tap differential pressure may be obtained. At step 404, a measured pressure loss ratio may be calculated as a ratio of the third tap differential pressure and the flow restriction differential pressure. At step 406, an ideal pressure loss ratio may be calculated. At step 408, a difference between the measured pressure loss ratio and the ideal pressure loss ratio may be compared to a threshold to determine if the gas in the pipe is carrying liquid (e.g., carrying any liquid, carrying sufficient amount of liquid). If the gas in the pipe is not carrying liquid, the process may return to step 402. If the gas in the pipe is carrying liquid, the liquid in the pipe may be quantified using the third tap at step 410. This may be performed by determining a value of the Lockhart-Martinelli parameter. At step 412, the value of the Lockhart-Martinelli parameter may be compared to a threshold (e.g., 0.02) to determine whether the gas flow rate needs to be corrected. If the value of the Lockhart-Martinelli parameter is less than a threshold value, then gas metering error caused by the liquid in the pipe is small and the process may return to step 402. If the value of the Lockhart-Martinelli parameter is greater than the threshold value, then the gas metering error caused by the liquid in the pipe may need to be calculated, and the overread of the gas flow rate may be calculated at step 414, such as by using ISO TR 12748. At step 416, a liquid-corrected gas flow rate may be calculated using the measured (uncorrected) gas flow rate and the overread of the gas flow rate. The amount of gas that is transferred through the pipe over a period of time may be accumulated using the liquid-corrected gas flow rate. At step 418, a liquid rate may be calculated using the value of the Lockhart-Martinelli parameter, the liquid-corrected gas flow rate, and a density ratio of liquid and gas. The amount of liquid that is transferred through the pipe over a period of time may be accumulated using the liquid rate.

The process shown in the flow diagram 400 is merely provided as an example and is not meant to be limiting. In some implementations, one or more steps may not be performed and/or additional steps may be performed. For instance, one or more of the decision steps 408, 412 may not be performed. For example, the decision step 408 or the decision step 412 may not be performed. As another example, neither of the decision steps 408, 412 may be performed. In some implementations, other methods of determining the value of the Lockhart-Martinelli parameter may be used. In such implementations, the process may begin with step 412 or step 414. In some implementations, underread of the gas flow rate may be calculated at step 414, and the liquid-corrected gas flow rate may be calculated using the measured (uncorrected) gas flow rate and the underread of the gas flow rate. That is, determination of the liquid-corrected gas flow rate in the pipe based on the value of the Lockhart-Martinelli parameter and the measured gas flow rate in the pipe may include: (1) determination of overread or underread of the gas flow rate in the pipe based on the value of the Lockhart-Martinelli parameter and/or other information; and (2) correction of the measured gas flow rate in the pipe based on the overread or the underread of the gas flow rate and/or other information.

In some implementations, correction of the measured gas flow rate in the pipe (the determination of the liquid-corrected gas flow rate in the pipe) may be iterated until convergence in the value of the liquid-corrected gas flow rate in the pipe is achieved. Individual iterations of the measured gas flow rate correction may include determination of a new value of a gas Froude number (based on the liquid-corrected gas flow rate). The new value of the gas Froude number may be used to calculate a new value of the overread/underread of the gas flow rate in the pipe, which may then be used to calculate a new value of the liquid-corrected gas flow rate in the pipe. Whether the iteration will continue may be determined based on a comparison of the latest calculated value of the liquid-corrected gas flow rate in the pipe (the liquid-corrected gas flow rate calculated in the current iteration, “calculated” liquid-corrected gas flow rate) and the previously calculated value of the liquid-corrected gas flow rate in the pipe (the liquid-corrected gas flow rate calculated in the previous iteration, “estimated” liquid-corrected gas flow rate), and/or other information. When the difference between the liquid-corrected gas flow rate calculated in the current iteration and the liquid-corrected gas flow rate calculated in the previous iteration is below a threshold value, the value of the liquid-corrected gas flow rate in the pipe may be deemed to have converged and the iteration may be stopped.

FIG. 4B illustrates an example flow diagram 450 for iteratively correcting gas flow in the presence of liquid in a gas pipeline. While FIG. 4B shows calculation of the overread of gas flow rate, this is merely as an example and is not meant to be limiting. In some implementations, the underread of gas flow rate may be calculated and used to correct the measured gas flow rate. At step 452, the overread (OR) of the measured gas flow rate in the pipe may be determined. In some implementations, the overread of the measured gas flow rate may be determined as explained above, such as based on the value of the Lockhart-Martinelli number (e.g., see ISO TR 12748). An input into the determination of the overread may include a value of the gas Froude number. At step 454, the value of the liquid-corrected gas flow rate (m_{g,i}) may be determined based on the overread and the measured gas flow rate (m_{g,measured}):

$${m}_{g , i} = \frac{{m}_{g , measured}}{OR}$$

At step 456, a comparison may be performed to determine whether another iteration will be performed. For the initial iteration (i=1), the comparison may determine the difference between the calculated liquid-corrected gas flow rate (m_{g,i}) and the measured gas flow rate (m_{g,measured}). For later iterations (i=2 or higher), the comparison may determine the difference between the liquid-corrected gas flow rate calculated in the current iteration (m_{g,i}) and the liquid-corrected gas flow rate calculated in the previous iteration (m_{g,i-1}). If the difference is higher than a threshold value, another iteration may be performed.

At step 458, for a new iteration, a new value of the gas Froude number may be determined. To determine the new value of the gas Froude number, the liquid-corrected gas flow rate calculated in the current iteration may be used to determine the superficial gas velocity (Vs_{g}). The superficial gas velocity may be determined using the below relationship.

$${Vs}_{g} = \frac{{m}_{g , i}}{{ρ}_{g} {A}_{p}} ,$$

where ρ_{g} is the density of gas and Aₚ is the cross-sectional area of the pipe

The superficial gas velocity may then be used to determine the new value of the gas Froude number, as explained above. The new value of the gas Froude number may be used as an input for determining the overread in the new iteration.

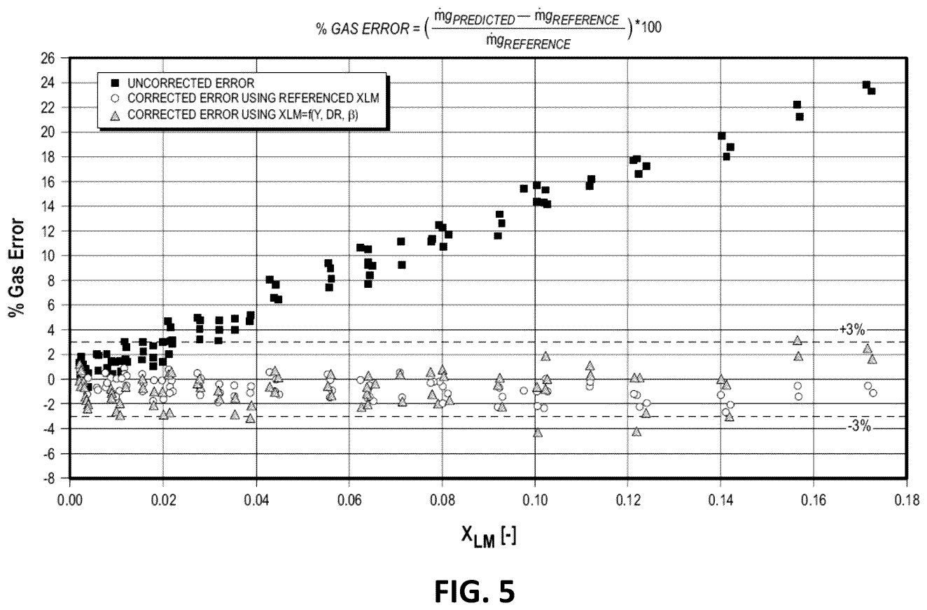

FIG. 5 illustrates an example correction of gas flow rate. FIG. 5 shows plots of gas flow rate error as a function of Lockhart-Martinelli number (value of Lockhart-Martinelli parameter). Larger Lockhart-Martinelli number may indicate greater amount of liquid (larger liquid fraction) in the pipe. Without correction, gas flow rate error increases with increasing liquid quantity in the pipe. Using the correction of gas flow rate via the third tap, the error in gas flow rate is reduced to about ±3% of the actual value.

Fast response pressure measurements from the pipe may be used to quantify liquid in the pipe and perform correction of gas flow rate. Fast response pressure measurements may include fast response absolute pressure measurements and/or fast response differential pressure measurements. Absolute pressure measurements may refer to pressures measured at particular points along the pipe. Fast response pressure measurements may be obtained using one or more fast response pressure sensors (dynamic pressure sensors) and/or one or more fast response differential pressure sensors. Fast response pressure measurements may be obtained upstream from the flow restriction, downstream from the flow restriction, at the flow restriction, and/or across the flow restriction. For example, fast response pressure measurements may include (1) fast response absolute pressure measurements upstream from the flow restriction, (2) fast response absolute pressure measurements downstream from the flow restriction, (3) fast response absolute pressure measurements at the flow restriction, (4) fast response differential pressure measurements upstream from the flow restriction, (5) fast response differential pressure measurements downstream from the flow restriction, (6) fast response differential pressure measurements across the flow restriction, and/or any combination thereof.

Gas flow rate error correction using fast response pressure measurements may be used in conjunction or separate from correction using the third tap. Fast response pressure measurements may be converted into the frequency domain, and the frequency of the fast response pressure measurements in the frequency domain may be used to determine the liquid quantity in the pipe. In some implementations, both the frequency and the amplitude of the fast response pressure measurements in the frequency domain may be used to determine the liquid quantity in the pipe. Once the liquid quantity in the pipe is determined (e.g., in form of a value of the Lockhart-Martinelli parameter), the overread/underread of the gas flow rate may be determined and used to correct the measured gas flow rate. The liquid-corrected gas flow rate may be used to determine the liquid flow rate in the pipe.

For example, a fast response differential pressure may be measured using one or more fast response differential pressure sensors and/or multiple dynamic pressure sensors. A fast response differential pressure sensor may include one or more fast response differential pressure transducers and/or one or more fast response differential pressure transmitters. A fast response differential pressure sensor or a dynamic pressure sensor may provide pressure measurements at a rate of 50 Hz or above. Other rates of measurement are contemplated.

Overread/underread of a gas flow rate in the pipe may be determined based on frequency, or frequency and amplitude of the fast response pressure measurements and/or other information. The absolute pressure and/or differential pressure may be measured by the fast response pressure sensor(s) in the time domain. The fast response pressure measurements may be converted into the frequency domain. Conversion of the fast response pressure measurements into the frequency domain may enable analysis using frequency characteristics of the fast response pressure measurements. For example, frequency of the fast response pressure measurements may be used in a wave frequency correlation to determine the liquid quantity in the pipe, which may then be used to correct the gas flow rate and determine the liquid flow rate in the pipe. For instance, the pulsation of liquid in the pipe may be characterized in the frequency domain to calculate the Strouhal number for fluid flowing in the pipe. The Strouhal number may refer to a dimensionless number describing oscillating flow mechanisms. The Strouhal number (St) for the fluid flowing in the pipe may be calculated as shown below. Other calculations of Strouhal number are contemplated.

$$St = \frac{f \cdot D}{{Vs}_{l}}$$

where f=dominant frequency, D=pipe diameter, and Vsₗ=superficial liquid velocity

Correlation may exist between the Strouhal number and the Lockhart-Martinelli number. Rather than calculating the Strouhal number, a wave frequency correlation may be used to establish an implicit relationship between the Strouhal number and the Lockhart-Martinelli number. This implicit relationship may be used in an overreading correlation and the definition of the Lockhart-Martinelli number to establish a relationship between (1) the measured gas flow rate, (2) the flow oscillating frequency, and (3) the liquid fluid velocity. This relationship may be used to determine the liquid velocity and subsequent variables (liquid flow rate, Lockhart-Martinelli number, liquid-corrected gas flow rate, etc.).

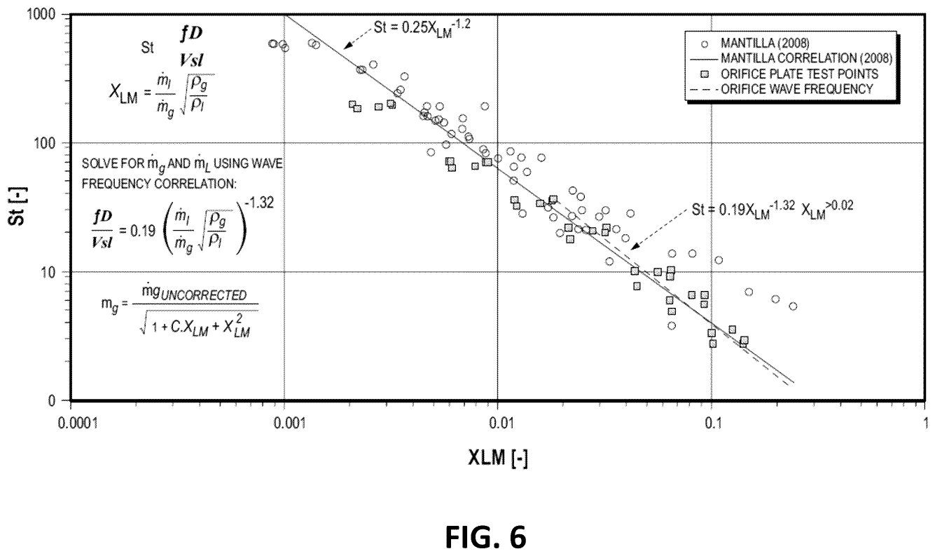

FIG. 6 illustrates example correlations between the Strouhal number and the Lockhart-Martinelli number. Using the correlation between the Strouhal number and the Lockhart-Martinelli number, the value of the Lockhart-Martinelli parameter for the calculated Strouhal number may be determined. For example, for Lockhart-Martinelli numbers greater than 0.02, the following relationship between the Strouhal number and the Lockhart-Martinelli number may be used to calculate the Lockhart-Martinelli number based on the Strouhal number. Use of other relationships between the Strouhal number and the Lockhart-Martinelli number is contemplated.

$$St = 0.19 \cdot {X}_{LM}^{- 1.32}$$

The correlation between the Strouhal number and the Lockhart-Martinelli number may be used to calculate the liquid-corrected gas flow rate and the liquid flow rate in the pipe. For example, the third tap may be used to determine whether the gas in the pipe is carrying liquid in the pipe as shown in steps 402-408 of FIG. 4A. If liquid is present in the pipe, the relationship between the Strouhal number and the Lockhart-Martinelli number may be used to calculate the liquid-corrected gas flow rate and the liquid flow rate in the pipe. For example, (1) the definition of Lockhart-Martinelli number as the function of liquid and gas flow rates and liquid and gas densities and (2) the definition of the Strouhal number as the function of dominant frequency, pipe diameter, and superficial liquid velocity may be inserted into the relationship between the Strouhal number and the Lockhart-Martinelli number, and expanded using an over-reading correlation to derive the below relationship. The below relationship may be used to determine the superficial liquid velocity based on dominant frequency, liquid and gas densities, pipe diameter, cross-sectional area of the pipe, and measured gas flow rate.

$$\frac{{ρ}_{l} {A}_{p} {V}_{sl} \sqrt{\frac{{ρ}_{g}}{{ρ}_{l}}}}{{( \frac{f D}{0.19 {V}_{sl}} )}^{\frac{- 1}{1.32}}} - \frac{{\dot{m}}_{g , measured}}{\sqrt{1 + C \cdot {( \frac{f D}{0.19 {V}_{sl}} )}^{\frac{- 1}{1.32}} + {( \frac{f D}{0.19 {V}_{sl}} )}^{\frac{- 2}{1.32}}}} = 0$$

The liquid flow rate may be determined as the product of the superficial liquid velocity and the cross-sectional area of the pipe (and the liquid density for liquid mass flow rate). The calculated liquid flow rate and the measured gas flow rate (along with liquid and gas densities) may be used to determine the value of the Lockhart-Martinelli number. The value of the Lockhart-Martinelli number, along with the gas Froude number and other information, may be used to determine the overread of the measured gas flow rate. The overread of the measured gas flow rate may be used to determine the liquid-corrected gas flow rate.

The frequency-based approach may include an iterative correction of gas flow rate. FIG. 4C illustrates an example flow diagram 460 for iteratively correcting gas flow in the presence of liquid in a gas pipeline. While FIG. 4C shows calculation of the overread of gas flow rate, this is merely as an example and is not meant to be limiting. In some implementations, the underread of gas flow rate may be calculated and used to correct the measured gas flow rate. At step 462, superficial liquid velocity for a pipe may be determined. The superficial liquid velocity may be determined based on dominant frequency, liquid and gas densities, pipe diameter, cross-sectional area of the pipe, and measured gas flow rate. At step 464, the value of the Lockhart-Martinelli number may be determined. For example, the liquid flow rate in the pipe may be determined based on the superficial liquid velocity, and the value of the Lockhart-Martinelli number may be determined based on the liquid flow rate and the liquid-corrected gas flow rate calculated in the previous iteration (along with liquid and gas densities). For the first iteration, the measured gas flow rate may be used as the liquid-corrected gas flow rate calculated in the previous iteration. At step 466, the overread (OR) of the measured gas flow rate in the pipe may be determined. For example, the overread (OR) of the measured gas flow rate in the pipe may be determined based on the value of the Lockhart-Martinelli and the value of the gas Froude number. Other values, such as water liquid mass ratio and density ratio may be used in the determination of the overread. At step 468, the value of the liquid-corrected gas flow rate (m_{g,i}) may be determined based on the overread and the measured gas flow rate (m_{g,measured}):

$${m}_{g , i} = \frac{{m}_{g , measured}}{OR}$$

At step 470, a comparison may be performed to determine whether another iteration will be performed. For the initial iteration (i=1), the comparison may determine the difference between the calculated liquid-corrected gas flow rate (m_{g,i}) and the measured gas flow rate (m_{g,measured}). For later iterations (i=2 or higher), the comparison may determine the difference between the liquid-corrected gas flow rate calculated in the current iteration (m_{g,i}) and the liquid-corrected gas flow rate calculated in the previous iteration (m_{g,i-1}). If the difference is higher than a threshold value, another iteration may be performed.

At step 472, for a new iteration, a new value of the gas Froude number may be determined. To determine the new value of the gas Froude number, the liquid-corrected gas flow rate calculated in the current iteration may be used to determine the superficial gas velocity (Vs_{g}). The superficial gas velocity may then be used to determine the new value of the gas Froude number. The new value of the gas Froude number may be used as an input for determining the overread in the new iteration. In the new iteration, the new value of the gas Froude number may be used to determine the value of C, which may then be used to determine the new value of superficial liquid velocity (step 462). The new value of superficial liquid velocity may be used to determine the liquid flow rate, which may in turn be used (along with the latest value of the liquid-corrected gas flow rate) to determine the new value of the Lockhart-Martinelli number (step 464).

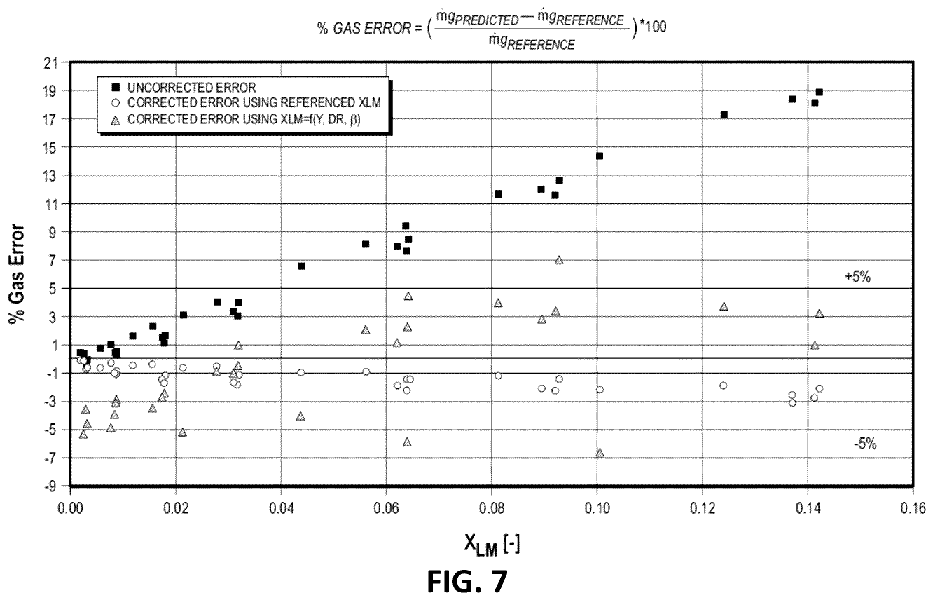

FIG. 7 illustrates an example correction of gas flow rate. FIG. 7 shows plots of gas flow rate error as a function of Lockhart-Martinelli number. Larger Lockhart-Martinelli number may indicate greater amount of liquid (larger liquid fraction) in the pipe. Without correction, gas flow rate error increases with increasing liquid quantity in the pipe. Using the correction of gas flow rate via the fast response pressure measurements, the error in gas flow rate is reduced to about ±7% of the actual value.

In some implementations, operation of the pipe (gas pipeline) may be controlled (e.g., started, stopped, set, changed) based on the liquid-corrected gas flow rate, the total transferred gas over a time period, and/or other information. For example, the type of gas that is transferred over the pipe and/or the rate of the gas flow through the pipe may be controlled based on the liquid-corrected gas flow rate, the total transferred gas over a time period, and/or other information. For instance, the rate of the gas flow through the pipe may be increased, slowed, or stopped based on the liquid-corrected gas flow rate, the total transferred gas over a time period, and/or other information. Allocation of revenue from gas and liquid may be altered based on the corrected gas flow rate and the liquid flow rate. Operating conditions may be altered to ensure that no liquid is present in the gas pipeline. The liquid may be removed by automated action in the operation.

While the present disclosure has been described with usage of pressure sensors, use of other types of sensors is contemplated. Other types of sensors may be used in conjunction with or separately from pressure sensors.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). A machine-readable medium may include non-transitory computer-readable medium. For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11. The system 10 may be implemented in a single computing device, across multiple computing devices, in a client-server environment, in a cloud environment, and/or in other devices/configuration of devices. The system 10 may be implemented using a computer, a desktop, a laptop, a phone, a tablet, a mobile device, a server, and/or other computing devices.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

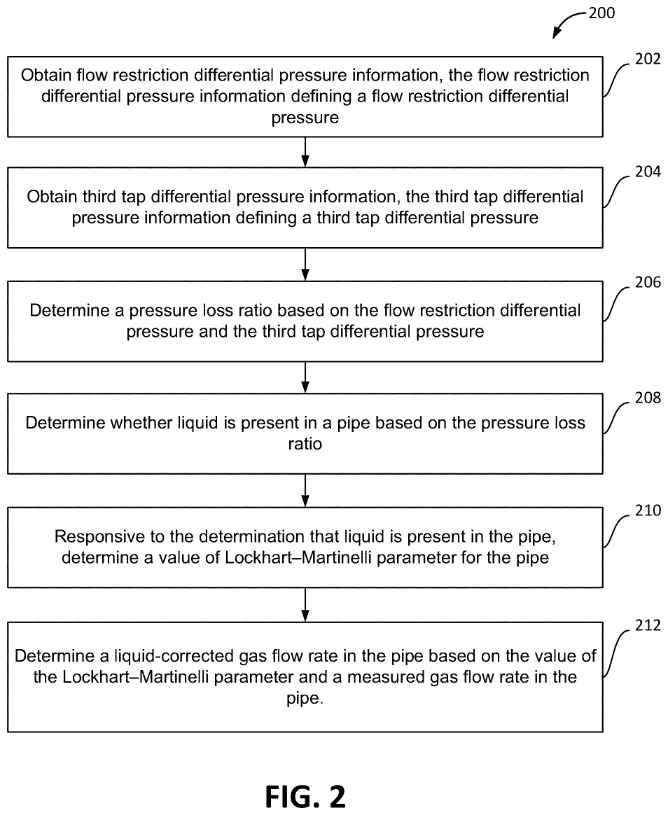

FIG. 2 illustrates method 200 for correcting gas flow in the presence of liquid in a gas pipeline. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, flow restriction differential pressure information may be obtained. The flow restriction differential pressure information may define a flow restriction differential pressure between a first point along a pipe and a second point along the pipe. A flow restriction may be located along the pipe. The first point may be on a first side of the flow restriction and the second point may be on a second side of the flow restriction. In some implementations, operation 202 may be performed by a processor component the same as or similar to the differential pressure component 102 (Shown in FIG. 1 and described herein).

At operation 204, third tap differential pressure information may be obtained. The third tap differential pressure information may define a third tap differential pressure between the first point along the pipe and a third point along the pipe. The third point may be on the second side of the flow restriction and may be downstream of the second point. In some implementations, operation 204 may be performed by a processor component the same as or similar to the differential pressure component 102 (Shown in FIG. 1 and described herein).

At operation 206, a pressure loss ratio may be determined based on the flow restriction differential pressure, the third tap differential pressure, and/or other information. In some implementations, operation 206 may be performed by a processor component the same as or similar to the pressure loss ratio component 104 (Shown in FIG. 1 and described herein).

At operation 208, whether liquid is present in the pipe may be determined based on the pressure loss ratio and/or other information. In some implementations, operation 208 may be performed using a processor component the same as or similar to the liquid presence component 106 (Shown in FIG. 1 and described herein).

At operation 210, responsive to the determination that liquid is present in the pipe, a value of Lockhart-Martinelli parameter for the pipe may be determined. In some implementations, operation 210 may be performed using a processor component the same as or similar to the Lockhart-Martinelli component 108 (Shown in FIG. 1 and described herein).

At operation 212, a liquid-corrected gas flow rate in the pipe may be determined based on the value of the Lockhart-Martinelli parameter, a measured gas flow rate in the pipe, and/or other information. In some implementations, operation 212 may be performed using a processor component the same as or similar to the correction component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for correcting gas flow rate in the presence of liquid in a gas pipeline, the system comprising:
one or more physical processors configured by machine-readable instructions to:
obtain flow restriction differential pressure information, the flow restriction differential pressure information defining a flow restriction differential pressure between a first point along a pipe and a second point along the pipe, a flow restriction located along the pipe, the first point being on a first side of the flow restriction and the second point being on a second side of the flow restriction;
obtain third tap differential pressure information, the third tap differential pressure information defining a third tap differential pressure between the first point along the pipe and a third point along the pipe, the third point being on the second side of the flow restriction and being downstream of the second point;
determine a pressure loss ratio based on the flow restriction differential pressure and the third tap differential pressure;
determine whether liquid is present in the pipe based on the pressure loss ratio;
responsive to the determination that liquid is present in the pipe, determine a value of Lockhart-Martinelli parameter for the pipe; and
determine a liquid-corrected gas flow rate in the pipe based on the value of the Lockhart-Martinelli parameter and a measured gas flow rate in the pipe.

2. The system of claim 1, wherein the one or more physical processors are further configured by the machine-readable instructions to determine a liquid flow rate in the pipe based on the liquid-corrected gas flow rate and the value of the Lockhart-Martinelli parameter.

3. The system of claim 2, wherein total transferred liquid over a time period is determined based on the liquid flow rate.

4. The system of claim 1, wherein total transferred gas over a time period is determined based on the liquid-corrected gas flow rate.

5. The system of claim 1, wherein the pressure loss ratio is determined as a ratio of the third tap differential pressure and the flow restriction differential pressure.

6. The system of claim 1, wherein the determination of whether liquid is present in the pipe based on the pressure loss ratio includes comparison of a difference between the pressure loss ratio and an ideal pressure loss ratio to a threshold to determine whether liquid is present in the pipe.

7. The system of claim 1, wherein the value of the Lockhart-Martinelli parameter for the pipe is determined based on a difference between the pressure loss ratio and an ideal pressure loss ratio, density ratio of gas to liquid, and geometry of the pipe.

8. The system of claim 1, wherein the value of the Lockhart-Martinelli parameter for the pipe is determined based on dominant frequency of fast response pressure measurements from the pipe.

9. The system of claim 8, wherein the fast response pressure measurements from the pipe include fast response absolute pressure measurements and/or fast response differential pressure measurements.

10. The system of claim 8, wherein the fast response pressure measurements are obtained upstream from the flow restriction, downstream from the flow restriction, at the flow restriction, and/or across the flow restriction.

11. The system of claim 1, wherein the flow restriction differential pressure is measured using a fast response differential pressure sensor.

12. The system of claim 11, wherein overread or underread of a gas flow rate in the pipe is determined based on frequency of the flow restriction differential pressure measured using the fast response differential pressure sensor.

13. The system of claim 12, wherein the overread or the underread of the gas flow rate in the pipe is determined further based on amplitude of the flow restriction differential pressure measured using the fast response differential pressure sensor.

14. The system of claim 1, wherein determination of the liquid-corrected gas flow rate in the pipe based on the value of the Lockhart-Martinelli parameter and the measured gas flow rate in the pipe includes:
determination of overread or underread of the gas flow rate in the pipe based on the value of the Lockhart-Martinelli parameter; and
correction of the measured gas flow rate in the pipe based on the overread or the underread of the gas flow rate.

15. The system of claim 1, wherein determination of the liquid-corrected gas flow rate in the pipe is iterated based on a comparison of a latest calculated value of the liquid-corrected gas flow rate in the pipe and a previously calculated value of the liquid-corrected gas flow rate in the pipe.

16. The system of claim 15, wherein the iterative determination of the liquid-corrected gas flow rate in the pipe includes determination of a value of a gas Froude number.

17. The system of claim 16, wherein the iterative determination of the liquid-corrected gas flow rate in the pipe further includes determination of a value of a superficial liquid velocity based on the value of the gas Froude number.

18. A method for correcting gas flow rate in the presence of liquid in a gas pipeline, the method comprising:
obtaining flow restriction differential pressure information, the flow restriction differential pressure information defining a flow restriction differential pressure between a first point along a pipe and a second point along the pipe, a flow restriction located along the pipe, the first point being on a first side of the flow restriction and the second point being on a second side of the flow restriction;
obtaining third tap differential pressure information, the third tap differential pressure information defining a third tap differential pressure between the first point along the pipe and a third point along the pipe, the third point being on the second side of the flow restriction and being downstream of the second point;
determining a pressure loss ratio based on the flow restriction differential pressure and the third tap differential pressure;
determining whether liquid is present in the pipe based on the pressure loss ratio;
responsive to the determination that liquid is present in the pipe, determining a value of Lockhart-Martinelli parameter for the pipe; and
determining a liquid-corrected gas flow rate in the pipe based on the value of the Lockhart-Martinelli parameter and a measured gas flow rate in the pipe.

19. The method of claim 18, further comprising determining a liquid flow rate in the pipe based on the liquid-corrected gas flow rate and the value of the Lockhart-Martinelli parameter.

20. The method of claim 19, wherein total transferred liquid over a time period is determined based on the liquid flow rate.
